(19) United States
(12) Patent Application Publication
(10) Pub. No.: US 2011/0164759 A1
(43) Pub. Date: Jul. 7, 2011

(54) ARRANGEMENT AND METHOD FOR MOUNTING A MICROPHONE TO AN INTERIOR SURFACE OF A VEHICLE

(75) Inventors: JESSE T. GRATKE, ROYAL OAK, MI (US); DARRYL T. FORNATORO, WARREN, MI (US)

(73) Assignees: GENERAL MOTORS LLC, DETROIT, MI (US); GM GLOBAL TECHNOLOGY OPERATIONS, INC., DETROIT, MI (US)

(21) Appl. No.: 12/683,040

(22) Filed: Jan. 6, 2010

(51) Int. Cl. H04R 1/02

(52) U.S. Cl. 381/91

(57) ABSTRACT

An arrangement for mounting a microphone to a surface in a passenger compartment of a vehicle includes, but is not limited to, a housing having an opening. The housing is configured to be mounted to the surface. A directional wideband microphone is mounted within the housing and positioned to partition the housing into a first chamber and a second chamber. The directional wideband microphone has an acoustic axis that extends through the first chamber. The housing and the directional wideband microphone cooperate to direct the acoustic axis in a predetermined direction.

### TECHNICAL FIELD

The technical field generally relates to a mounting arrangement for microphones.

### BACKGROUND

Many current vehicles in the marketplace are equipped with communication equipment that enables a vehicle occupant to engage in verbal communications with remotely located entities such as a call center and/or other parties. In some cases, the communication equipment uses voice recognition software to permit the vehicle occupant to give verbal commands to control the communication equipment itself and/or other equipment in the vehicle. Accordingly, the communication equipment typically includes a microphone to facilitate the vehicle occupant's uses of the communication equipment.

It has been observed that as the frequency of a human voice increases, the effectiveness of some microphones to receive the human voice diminishes. It has been determined that wideband microphones are more effective than non-wideband microphones at receiving human voices at higher frequencies. In some instances, it has been observed that a wideband microphone provides a 2-3% improvement over non-wideband microphones when receiving high frequency voice transmissions in conjunction with voice recognition software.

It is also known that the use of microphones that are designed to be relatively highly receptive to sound energy in a predetermined direction can further assist in receiving high frequency human voice transmissions. Such microphones are commonly known as directional microphones. The direction of a directional microphone's relatively high receptivity to sound energy will be referred to herein as the “acoustic axis” of the directional microphone.

When a directional wideband microphone is used in conjunction with the communication equipment discussed above, the directional microphone is typically mounted within a housing and is oriented so that the acoustic axis extends in a direction generally transverse to the housing. Once positioned in the housing, a sound isolating member is typically positioned over the directional microphone. The sound isolating member is configured to redirect the acoustic axis of the directional microphone so that the acoustic axis extends in a desired direction.

It has been observed that some mounting arrangements used to mount directional wideband microphones to an interior surface of a vehicle, including some which employ the sound isolating member described above, can adversely affect the directional wideband microphone's ability to receive high frequency voice transmissions, and thus negate or diminish the benefits derived from the use of a wideband microphone.

Accordingly, a mounting arrangement that does not significantly diminish a directional wideband microphone's ability to receive high frequency voice transmissions is desirable. Furthermore, other desirable features and characteristics will become apparent from the subsequent detailed description and the appended claims, taken in conjunction with the accompanying drawings and the foregoing technical field and background.

### SUMMARY

An arrangement and method are provided for mounting a microphone to a surface in a passenger compartment of a vehicle. In a first, non-limiting example, an arrangement includes, but is not limited to, a housing having an opening. The housing is configured to be mounted to the surface. A directional wideband microphone is mounted within the housing and positioned to partition the housing into a first chamber and a second chamber. The directional wideband microphone has an acoustic axis that extends through the first chamber. In this first non-limiting example, the housing and the directional wideband microphone cooperate to direct the acoustic axis in a predetermined direction.

In a second, non-limiting example, an arrangement includes, but is not limited to, a housing having an opening. The housing is configured to be mounted to the surface. A directional wideband microphone is mounted within the housing and is positioned to partition the housing into a first chamber and a second chamber. The directional wideband microphone has an acoustic axis that extends through the first chamber. The directional wide band microphone is positioned a distance from a far wall of the first chamber that is less than a length of a wavelength of a frequency of interest. In this second non-limiting example, the housing and the directional wideband microphone cooperate to direct the acoustic axis in a predetermined direction.

In a third, non-limiting example, an arrangement includes, but is not limited to, a housing having an opening. The housing is configured to be mounted to the surface. A directional wideband microphone is mounted within the housing and is positioned to partition the housing into a first chamber and a second chamber. The directional wideband microphone has an acoustic axis that extends through the first chamber. The directional wide band microphone is positioned a distance from a far wall of the first chamber that is less than a length of a wavelength of a frequency of interest. A mass of sound absorbing material is disposed in the front chamber. In this third non-limiting example, the housing and the directional wideband microphone cooperate to direct the acoustic axis in a predetermined direction.

### DESCRIPTION OF THE DRAWINGS

One or more examples will hereinafter be described in conjunction with the following drawing figures, wherein like numerals denote like elements, and

FIG. 1 is a schematic view illustrating a non-limiting example of a communication system suitable for use with communication devices that include examples of arrangements for mounting a microphone to an interior surface of a vehicle disclosed herein;

FIG. 2 is a schematic, fragmented, cut-away side view illustrating an interior of a vehicle that is equipped with an example of an arrangement for mounting a microphone to an interior surface of a vehicle;

FIG. 3 is a schematic cross-sectional view of a non-limiting example of an overhead console configured to house an example of an arrangement for mounting a microphone to an interior surface of the vehicle;

FIG. 4A is a cross-sectional, schematic view illustrating an example of an arrangement for mounting a microphone to an interior surface of a vehicle;

FIG. 4B is a plan view of the arrangement of FIG. 4A;

FIG. 5 is an exploded view illustrating various components of an example of a directional, wideband microphone sub-assembly that is compatible with the arrangement illustrated in FIG. 3;

FIG. 6 is a perspective view of a rear portion of the directional, wideband microphone sub-assembly of FIG. 5

FIG. 7 is a perspective view of a front portion of the directional, wideband microphone sub-assembly of FIG. 5;

FIG. 8 is a cross-sectional, schematic view illustrating an alternate example of an arrangement for mounting a microphone to an interior surface of a vehicle; and

FIG. 9 is a flow chart illustrating a method of assembling an arrangement for mounting a microphone to an interior surface of a vehicle.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

In some non-limiting examples, it may be desirable for a directional microphone to have a frequency response that goes from 300 Hz to 8000 Hz with a variance of less than 2 dB per octave while preserving its directional properties throughout the entire range. In other examples, different ranges and/or different variances may be desirable. Regardless of specific performance goals and specifications, the diminution of a directional wideband microphone's high frequency voice transmission receptivity (hereinafter, “high frequency receptivity”) can be at least partially offset by configuring the arrangement that is used to mount the microphone to a surface in a manner that enhances the high frequency receptivity of the microphone. For example, the sound isolating member which is used in prior art arrangements to focus the acoustic axis of the directional wideband microphone may be removed. Removal of the sound isolating member eliminates a source of high frequency interference which causes a diminution in the high frequency receptivity of the directional wideband microphone. A vibration isolating member, or boot, may at least partially surround the directional wideband microphone to further prevent high frequency interference. The directional wideband microphone may further be mounted in a housing and oriented with respect to the housing such that the acoustic axis is directed by the directional wideband microphone to extend in a direction that is substantially parallel to a surface of the housing. The directional wideband microphone and the housing will then cooperate to angle or deflect the acoustic axis in a desired direction. In some examples, it may be desirable to direct the acoustic axis to extend towards an occupant of a vehicle in which the directional wideband microphone is mounted. In some examples, the housing and the directional wideband microphone may cooperate to direct the acoustic axis toward a mouth of the occupant.

In some examples, the directional wideband microphone may be mounted to, and electrically connected to, a preamplifier. In some examples, the preamplifier may be positioned above the directional wideband microphone to minimize high frequency interference with the directional wideband microphone. In other examples, the preamplifier may be built into the microphone.

In still other examples, the directional wideband microphone may be mounted to the housing in an orientation that is oblique with respect to the surface of the housing or may otherwise be mounted in a manner that causes the directional wideband microphone to direct the acoustic axis to extend at an angle that is oblique with respect to the surface of the housing. When mounted in an overhead console or headliner of a vehicle, mounting the directional wideband microphone in an oblique manner permits the housing and the directional wideband microphone to cooperate to deflect the acoustic axis further than the deflection caused when the directional wideband microphone directs the acoustic axis to extend in a substantially parallel direction with respect to the surface of the housing. This may be desirable in vehicles where the driver sits close to the directional wideband microphone. In such circumstances, it may be desirable to have a higher degree of deflection to direct the acoustic axis towards the driver's mouth. In each of the arrangements discussed above, the wideband frequency response of the microphone is not altered by the housing. This is due, in part, to the omission of the sound isolating member discussed above.

A greater understanding of the examples of the apparatus disclosed herein may be obtained through a review of the illustrations accompanying this application together with a review of the detailed description that follows.

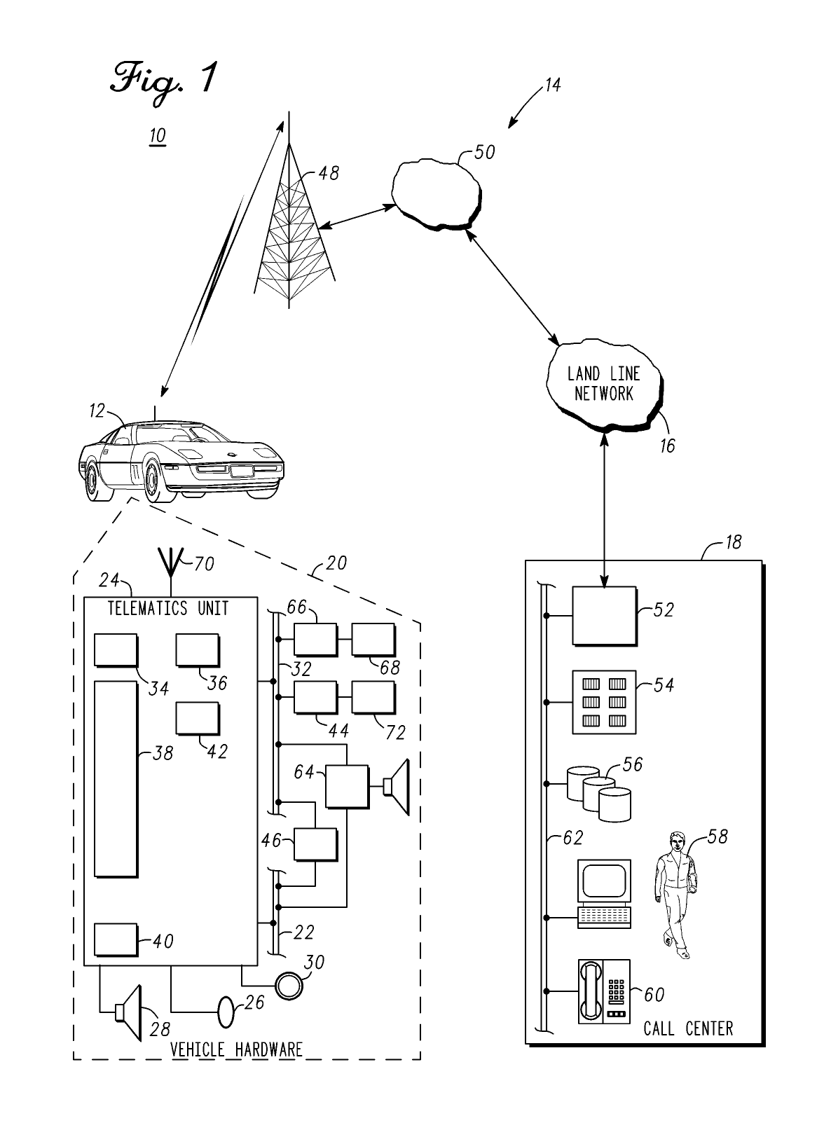

With reference to FIG. 1, there is shown a non-limiting example of a communication system 10 that may be used in conjunction with examples of the apparatus disclosed herein. The communication system generally includes a vehicle 12, a wireless carrier system 14, a land network 16 and a call center 18. It should be appreciated that the overall architecture, setup and operation, as well as the individual components of the illustrated system are merely exemplary and that differently configured communication systems may also be utilized in conjunction with the examples of the apparatus disclosed herein. Thus, the following paragraphs, which provide a brief overview of the illustrated communication system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over communication system 10. Some of the vehicle hardware 20 is shown generally in FIG. 1, including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a dual mode antenna 70, and a navigation unit containing a GPS chipset/component 42. In one example, the wireless modem 36 includes a computer program and/or set of software routines adapted to be executed within electronic processing device 38.

The telematics unit 24 may provide various services including: turn-by-turn directions and other navigation-related services provided in conjunction with the GPS based chipset/component 42; airbag deployment notification and other emergency or roadside assistance-related services provided in connection with various crash and/or collision detection sensor interface modules 66 and collision sensors 68 located throughout the vehicle; and/or infotainment-related services where music, Internet web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services that the telematics unit may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular chipset/component 34 for voice communications and the wireless modem 36 for data transmission. In order to enable successful data transmission over the voice channel, wireless modem 36 applies some type of encoding or modulation to convert the digital data so that it can be communicated through a vocoder or speech codec incorporated in the cellular chipset/component 34. Any suitable encoding or modulation technique that provides an acceptable data rate and bit error can be used with the present examples. Dual mode antenna 70 services the GPS chipset/component 42 and the cellular chipset/component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware also includes one or more buttons and/or controls 30 for enabling a vehicle occupant to activate or engage one or more components of the vehicle hardware 20. For example, one of the buttons and/or controls 30 can be an electronic pushbutton used to initiate voice communication with call center 18 (whether it be a human such as advisor 58 or an automated call response system). In another example, one of the buttons and/or controls 30 can be used to initiate emergency services.

The vehicle audio component 64 is operatively connected to the vehicle bus 32 and the audio bus 22. The vehicle audio component 64 receives analog information, rendering it as sound, via the audio bus 22. Digital information is received via the vehicle bus 32. The vehicle audio component 64 provides amplitude modulated (AM) and frequency modulated (FM) radio, compact disc (CD), digital video disc (DVD), and multimedia functionality independent of the infotainment center 46. Vehicle audio component 64 may contain a speaker system, or may utilize speaker 28 via arbitration on vehicle bus 32 and/or audio bus 22.

The vehicle crash and/or collision detection sensor interface modules 66 is operatively connected to the vehicle bus 32. The collision sensors 68 provide information to the telematics unit via the crash and/or collision detection sensor interface modules 66 regarding the severity of a vehicle collision, such as the angle of impact and the amount of force sustained.

Vehicle sensors 72, connected to various sensor interface modules 44 are operatively connected to the vehicle bus 32. Example vehicle sensors include but are not limited to gyroscopes, accelerometers, magnetometers, emission detection, and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48, base stations and/or mobile switching centers (MSCs) 50, as well as any other networking components required to connect the wireless carrier system 14 with land network 16. As appreciated by those skilled in the art, various cell tower/base station/MSC arrangements are possible and could be used with wireless carrier system 14. For example, a base station and a cell tower could be co-located at the same site or they could be remotely located, and a single base station could be coupled to various cell towers or various base stations could be coupled with a single MSC, to list but a few of the possible arrangements. A speech codec or vocoder may be incorporated in one or more of the base stations, but depending on the particular architecture of the wireless network, it could be incorporated within a Mobile Switching Center or some other network components as well.

Land network 16 can be a conventional land-based telecommunications network that is connected to one or more landline telephones, and that connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

Call center 18 is designed to provide the vehicle hardware 20 with a number of different system back-end functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either the live advisor 58 or an automated response system, and data transmissions are passed on to a modem or other piece of equipment 60 for demodulation and further signal processing. The modem 60 may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a manned call center 18, it will be appreciated that the call center 18 can be any central or remote facility, manned or unmanned, mobile or fixed, to or from which it is desirable to exchange voice and data.

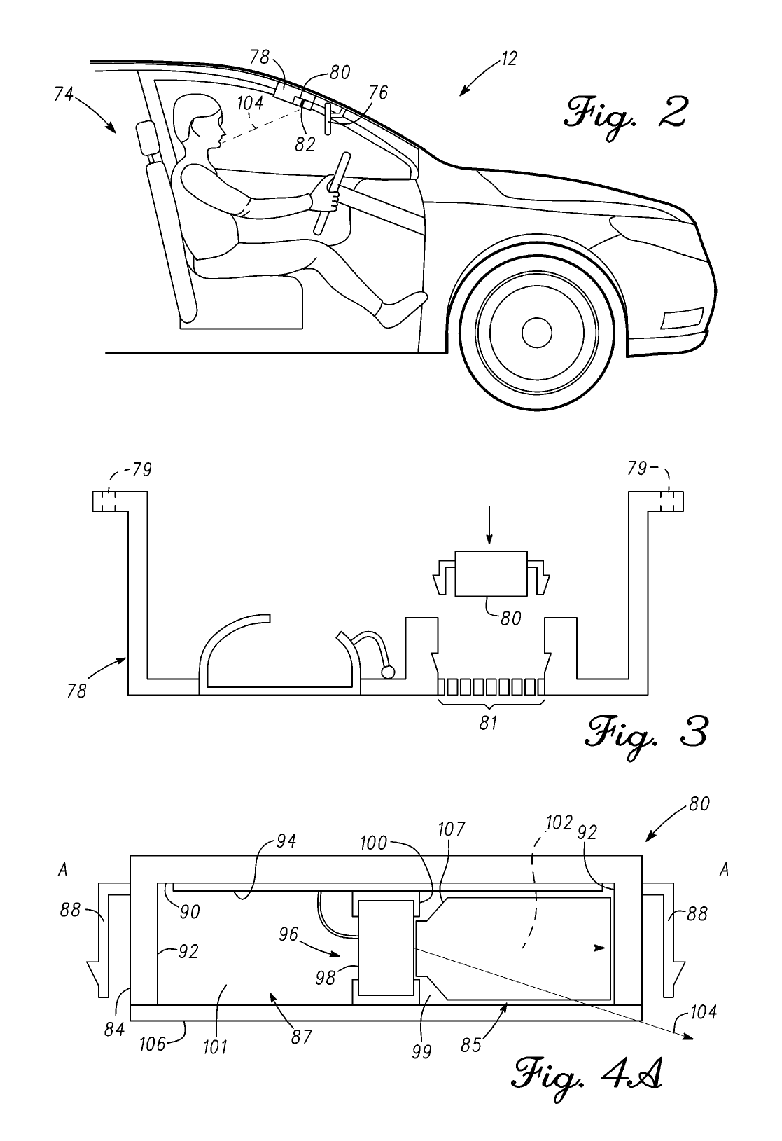

FIG. 2 is a schematic, fragmented, cut-away side view illustrating an interior 74 of a vehicle 12 that is equipped with an example of an arrangement disclosed herein for mounting a microphone to an interior surface of a vehicle.

Vehicle 12 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). Although an automobile is depicted in FIG. 2, it should be understood that the teachings of the present disclosure are equally compatible with other sorts of vehicles including air craft, water craft and space craft.

Interior 74 includes a rear view mirror 76 that permits a driver of vehicle 12 to observe traffic and other conditions located to the rear of vehicle 12. Buttons and/or controls 30 (see FIG. 1) may be mounted on a lower portion of rear view mirror 76 and may be configured to send a signal to telematics unit 24 (see FIG. 1) requesting an action. For example, when depressed, buttons and/or controls 30 may transmit a signal to telematics unit 24 to initiate contact with call center 18. Buttons and/or controls 30 may be mounted to any suitable surface within interior 74.

Vehicle 12 includes an overhead console 78 mounted to an upper surface of interior 74. In some examples, overhead console 78 may be mounted to a headliner. In other examples, overhead console 78 may be mounted to a roof portion of vehicle 12, or to any other suitable surface. Overhead consoles such as overhead console 78 may provide a wide variety of features and/or components including, without limitation, internal rear view mirrors, eyeglass holders, reading lights, universal garage door openers, storage compartments, and the like. In some examples, a microphone assembly 80 may be mounted to, or within, overhead console 78. Such mounting may be accomplished through the use of mechanical fasteners, threaded fasteners, adhesives, epoxies, welds, snap fit arrangements, or through any other means or combination of means effective to mount microphone assembly 80 to overhead console 78. It should be understood that, although the arrangements for mounting a microphone discussed and illustrated herein are shown and discussed in conjunction with mounting a microphone to an overhead console, the arrangements disclosed herein are compatible with other surfaces and/or components.

In the illustrated example, microphone assembly 80 houses directional wideband microphone 82 and may be used by a driver or other occupant of vehicle 12 to verbally communicate with an advisor 58 at call center 18 and/or to interact with telematics unit 24, or with other portions of the vehicle hardware 20. In the illustrated example, overhead console 78 and microphone assembly 80, are positioned generally in an area above, and forward of, a location where the driver of vehicle 12 is expected to sit.

With respect to FIG. 3, a schematic cross-sectional view of a non-limiting example of overhead console 78 is illustrated. Overhead console 78 is configured to receive microphone assembly 80 in a snap fit relationship. In other examples, microphone assembly 80 may be mounted to overhead console 78 in any manner effective to permit overhead console 78 to retain microphone assembly 80. Overhead console 78 includes openings 79 for mounting overhead console 78 to a roof or other structure or surface within interior 74. In other examples, any suitable means for attaching overhead console 78 to a roof or other structure or surface within interior 74 may be employed. A bottom side of overhead console 78 faces into interior 74 when overhead console 78 is mounted to the roof of vehicle 12.

Overhead console 78 includes an integral grill 81 adjacent to an area where microphone assembly 80 resides in order to permit sound to enter microphone assembly 80. In some examples, grill 81 may be acoustically transparent. As used herein, the term “acoustically transparent” when used in conjunction with a structure shall refer to a structure having one or more openings passing through solid portions of the structure wherein the ratio of open area to solid area is sufficient to permit the transmission of audible sound energy through the structure without any diminution in audibility. In other examples, grill 81 may not be integral with overhead console 78 but instead may be fabricated separately and attached to overhead console 78 in any manner effective to provide a secure attachment.

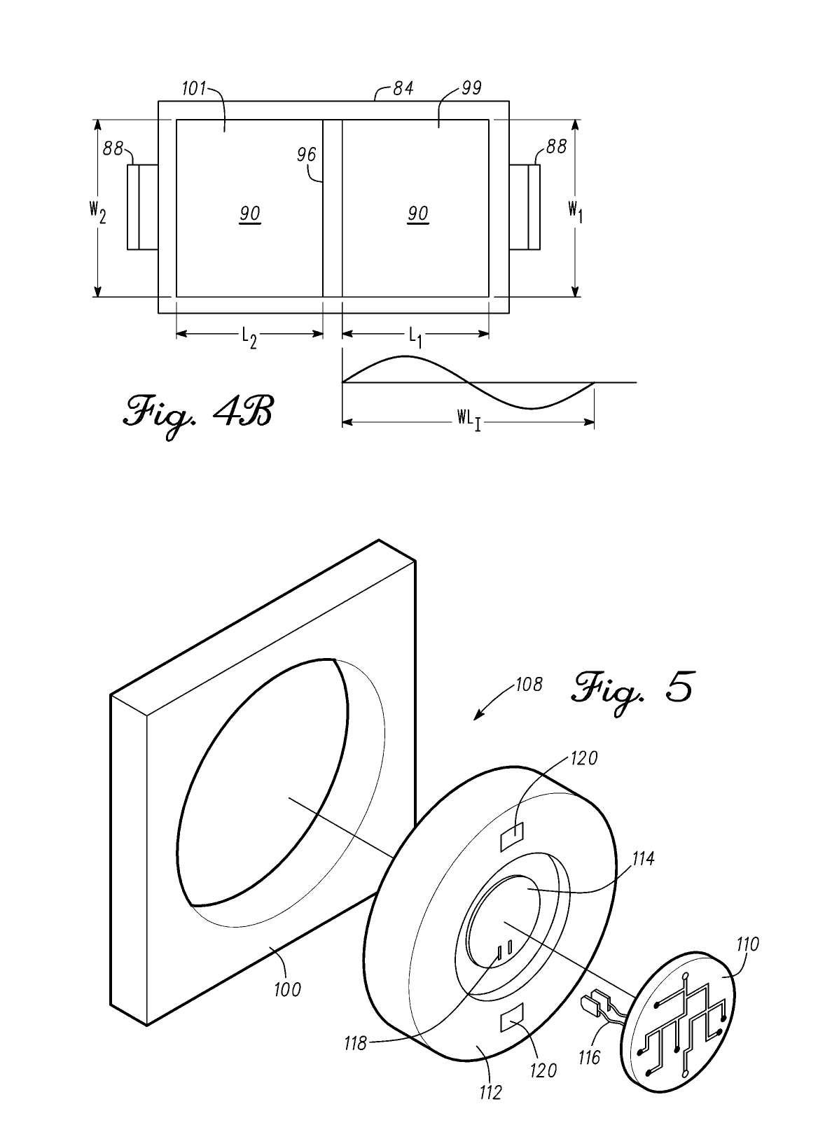

With respect to FIG. 4A, a schematic cross-sectional view is presented of a non-limiting example of a microphone assembly 80 made in accordance with the teachings of the present disclosure. In the illustrated example, microphone assembly 80 includes a housing 84. Housing 84 may be made of any suitable material including, without limitation, metals, plastics, ceramics and wood.

In the illustrated example, housing 84 has a generally rectangular configuration and a central axis A-A. In other examples, other suitable configurations may be employed. In some examples, housing 84 may need to be constructed in accordance with previously existing specifications to provide backwards compatibility with existing microphone assembly mounts.

In the illustrated example, housing 84 includes a pair of oppositely disposed snap-fit features 88. Snap-fit features 88 are configured to engage a snap fit mount integrated into, or attached to, overhead console 78. In other examples, the pair of snap-fit features 88 may be disposed on other surfaces of housing 84. In still other examples, a greater or lesser number of snap-fit features 88 may be employed. In other examples, any suitable attachment means may be employed.

Housing 84 includes a mounting surface 90. Mounting surface 90 serves as the ceiling of housing 84 and is generally co-planar with central axis A-A. Housing 84 further includes a pair of oppositely disposed walls 92 which are attached to opposite ends of mounting surface 90 and which are disposed generally transverse to mounting surface 90.

A preamplifier 94 is attached to mounting surface 90. Preamplifier 94 serves to amplify low level audio signals. Preamplifier 94 may be attached to mounting surface 90 in any suitable manner including, without limitation, through the use of adhesives, welds, threaded fasteners and mechanical fasteners. In other examples, discussed below, preamplifier 94 may be attached elsewhere.

A microphone sub-assembly 96 is mounted to preamplifier 94 and is electrically connected thereto. In other examples, microphone sub-assembly 96 may be mounted to housing 84 and electrically connected to preamplifier 94. In the example illustrated in FIG. 4A, microphone sub-assembly 96 includes a directional wideband microphone 98. In the illustrated example, directional wideband microphone 98 is an electret condenser microphone. In other examples, other types of directional wideband microphones may be used.

Microphone sub-assembly 96 further includes a vibration isolating member or boot 100. Boot 100 may be made from rubber materials, plastic materials, elastomeric materials and/or any other materials effective to permit boot 100 to isolate directional wideband microphone 98 from vibrations. In the illustrated example, and as best seen in FIG. 5, boot 100 is rectangular with openings on opposite sides. In other examples, boot 100 may have any suitable shape and/or configuration. Directional wideband microphone 98 fits within, and is at least partially enveloped by, boot 100.

Microphone sub-assembly 96 is positioned within, and mounted to, housing 84 in a manner that partitions housing 84 into a first chamber 99 and a second chamber 101. A first opening 85 allows sound to enter first chamber 99. A second opening 87 allows sound to enter second chamber 101. In some examples, microphone sub-assembly 96 substantially seals first chamber 99 from second chamber 101 to substantially obstruct the direct transmission of sound between the two chambers. It has been observed that when the volume of first chamber 99 is substantially equal to the volume of second chamber 101, the frequency response of directional wideband microphone 98 is substantially unaltered.

In the example in FIG. 4A, directional wideband microphone 98 includes an acoustic axis 102 (illustrated in phantom lines) projecting outwardly in a direction that is generally perpendicular to directional wideband microphone 98. Microphone sub-assembly 96 is mounted within housing 84 such that directional wideband microphone 98 is generally perpendicular to mounting surface 90 and such that directional wideband microphone 98 directs acoustic axis 102 to extend in a direction that is substantially parallel to mounting surface 90 and to central axis A-A.

Because directional wideband microphone 98 is disposed within housing 84 in a manner such that substantially all portions of directional wideband microphone 98 are positioned above lower surfaces of walls 92, housing 84 cooperates with directional wideband microphone 98 to deflect acoustic axis 102 in a downward direction, resulting in acoustic axis 104. When microphone assembly 80 is mounted in overhead console 78, downwardly extending acoustic axis 104 extends towards a driver of vehicle 12. In some examples, the downward deflection of acoustic axis 102 permits acoustic axis 104 to point or extend toward a mouth of a person driving vehicle 12. Exclusion of the sound isolating member, discussed above in the background section, helps to avoid alteration of the frequency response of directional wideband microphone 98.

An acoustic textile 106 is positioned over first and second openings 85, 87, and in this manner, is disposed between directional wideband microphone 98 and sources of sound. Acoustic textile 106 impedes the flow of sound waves through first and second openings 85, 87. Acoustic textile 106 removes sound energy from sound waves as they pass through first and second openings 85, 87 and converts the sound energy to some other form of energy, for instance, heat or mechanical energy. The material comprising acoustic textile 106 may be selected based on its acoustic impedance. A material's acoustic impedance equals the density of the material multiplied by the material's speed of sound. Based on the material selected, the acoustic textile can be tuned to filter out, or otherwise diminish, sound waves of a particular frequency. In this manner, if the directional wideband microphone has an elevated sensitivity or an otherwise undesired response to sound of a particular frequency, acoustic textile 106 can muffle or diminish the strength of the sound waves of that particular frequency before they reach directional wideband microphone 98 and thus contribute to a wideband microphone's generally flat response across its entire frequency bandwidth. Additionally, acoustic textile 106 is porous to permit sound to pass through it. The porosity of acoustic textile 106 need not be uniform. Rather, the porosity of acoustic textile 106 may vary throughout the material. By varying its porosity, acoustic textile 106 may be used to tune the frequency response of directional wideband microphone 98. Acoustic textile 106 may also serve generally as a cover to protect microphone sub-assembly 96 from dust, spills, debris or other items.

A mass 107 of sound absorbing material is illustrated in first chamber 99. Mass 107 acts as an acoustic resistance and attenuates any standing waves in an enclosed volume. An increase in the mass of mass 107 will decrease a resonance frequency inherent within first chamber 99 and serves to attenuate any elevations in the frequency response of directional wideband microphone 98. Mass 107 may comprise a foam material. A wide variety of different foams may be used. The different densities and porous textures of differing foam materials act at specific frequencies. Mass 107 may have any suitable shape and may have any suitable density. An appropriate shape and density utilized for a particular application may be arrived at through a process of trial and error, with different shapes and different densities being tested until a desired frequency response for directional wideband microphone 98 is obtained. In other examples, a second mass of sound absorbing material may also be positioned in second chamber 101.

With respect to FIG. 4B, a view is presented of housing 84 from beneath housing 84. For illustrative purposes, acoustic textile 106 and mass 107 (shown in FIG. 4A) have been removed. In the example illustrated in FIG. 4B, first chamber 99 and second chamber 101 are substantially rectangular. First chamber 99 is bounded at its left side by microphone sub-assembly 96. Extending to the right from microphone sub-assembly 96 is a pair of walls each having a length L1. A far wall disposed opposite microphone sub-assembly 96 has a width W1. Mounting surface 90 serves as a ceiling for first chamber 99. First opening 85 (see FIG. 4A) is disposed opposite to mounting surface 90 to allow sound to enter first chamber 99. Similarly, second chamber 101 is bounded on its right side by microphone sub-assembly 96. Extending to the left from microphone sub-assembly 96 is a pair of walls each having a length L2. A far wall disposed opposite microphone sub-assembly 96 has a width W2. Mounting surface 90 serves as a ceiling for second chamber 101. Second opening 87 (see FIG. 4A) is disposed opposite to mounting surface 90. In the example illustrated in FIGS. 4A and B, first chamber 99 is substantially rectangular, and first opening 85 has a width equal to W1 and a length equal to L1. Similarly, second chamber 101 is substantially rectangular, and second opening 87 has a width equal to W2 and a length equal to L2. It has been observed that when first opening 85 and second opening 87 have substantially the same surface area (i.e., L1=L2 and W1=W2), the frequency response of directional wideband microphone 112 remains substantially unaltered.

It has further been observed that when L1 is less than a length of a wavelength of interest, the frequency response of directional wideband microphone 98 is substantially unaltered. As used herein, the term “wavelength of interest” refers to the wavelength of sound having the highest frequency that is desired to be detected by directional wideband microphone 112. The higher the frequency, the shorter the wavelength. A single period of wavelength of Interest, WLI, is illustrated in FIG. 4B. If the length L1 from directional microphone sub-assembly 96 to the far wall is less than the wavelength of interest (WLI), then there is less likely to be sound waves reflecting off of the far wall therefore a lower likelihood of interference between sound waves that would otherwise diminish the ability of directional wideband microphone 112 to detect and receive sound.

An alternate example of a microphone sub-assembly made in accordance with the teachings of the present disclosure is illustrated in FIG. 5. In FIG. 5, an exploded view is presented which illustrates various components of a microphone sub-assembly 108. Microphone sub-assembly 108 includes a preamplifier 110, a directional wideband microphone 112 and boot 100. Microphone sub-assembly 108 differs from microphone sub-assembly 96, in that, in microphone sub-assembly 108, preamplifier 110 is disposed within a recess 114 defined within directional wideband microphone 112 while microphone sub-assembly 96 does not include an integrated preamplifier.

Preamplifier 110 is configured to be electrically connected to directional wideband microphone 112 via leads or wires 116. Directional wideband microphone 112 includes receivers 118 to receive leads or wires 116. In other examples, preamplifier 110 may plug into directional wideband microphone 112 with rigid prongs or in any other suitable manner that permits the electrical connection between directional wideband microphone 112 and preamplifier 110 to serve as the mechanical connection between these components.

Directional wideband microphone 112 includes two sound receiving portions 120 on a rear facing surface of directional wideband microphone 112. In other examples, a greater or lesser number of sound receiving portions 120 may be disposed on the rear facing surface of directional wideband microphone 112. These sound receiving portions 120 permit sound to enter a rear portion of directional wideband microphone 112 and through the use of well known noise cancellation techniques, allow directional wideband microphone 112 to have directional listening capabilities.

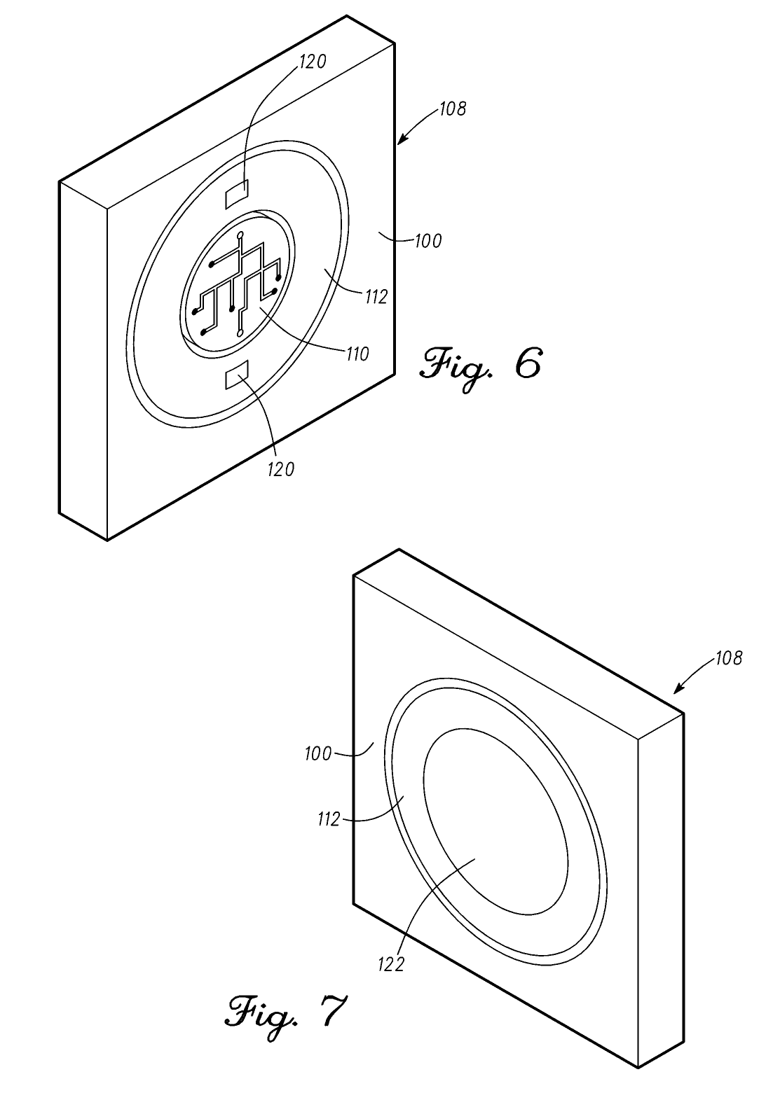

With respect to FIGS. 6 and 7, perspective views are presented of a back portion and a front portion, respectively, of microphone sub-assembly 108. In FIG. 7, a primary sound receiving portion 122 is illustrated. Primary sound receiving portion 122 permits sound energy to enter a front portion of directional wideband microphone 112. Acoustic axis 102 (not shown in FIG. 7) extends outwardly from sound receiving portion 122.

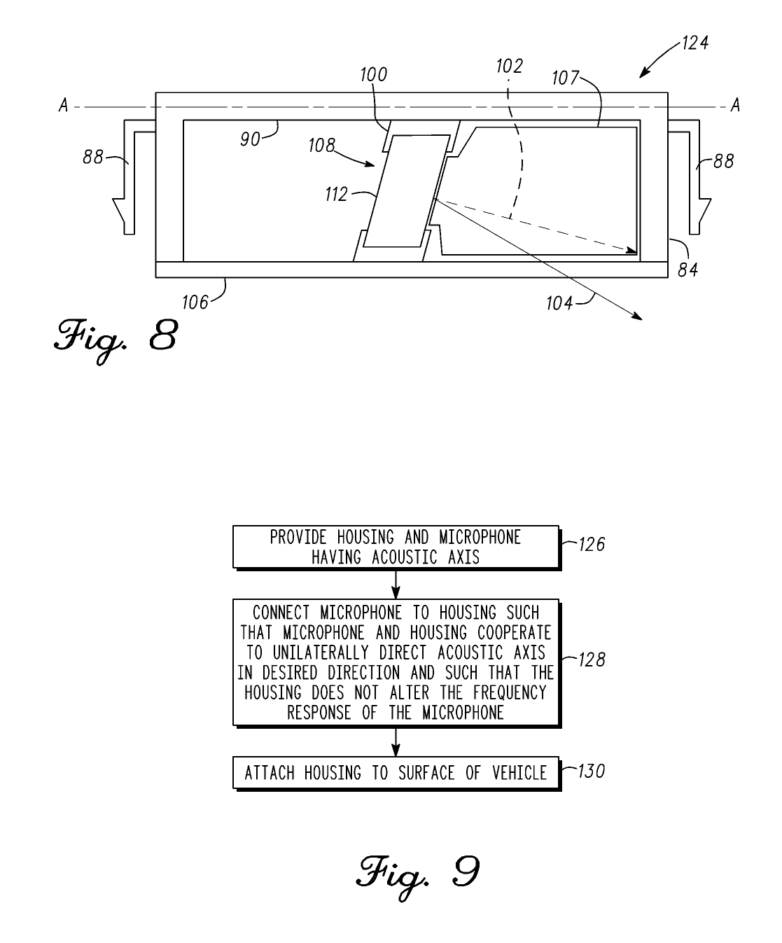

With respect to FIG. 8, another non-limiting example of a microphone assembly 124 made in accordance with the teachings of the present disclosure, is illustrated. In the example of FIG. 8, microphone sub-assembly 108 is mounted within housing 84 at an oblique angle with respect to mounting surface 90 and central axis A-A. Accordingly, acoustic axis 102, illustrated in phantom lines, is directed to extend from directional wideband microphone 112 at an angle that is oblique with respect to mounting surface 90 and to central axis A-A. This initial downward deflection results in additional downward deflect of acoustic axis 104 when housing 84 and directional wideband microphone 112 cooperate to deflect acoustic axis 102. In this manner, canting microphone subassembly 108 at an angle with respect to mounting surface 90 enhances an ability to direct acoustic axis 104 towards a point in space where a driver's mouth is expected to be. In other examples, microphone assembly 124 may be canted at an oblique angle to achieve the same effect.

With respect to FIG. 9, a flow chart is presented illustrating a non-limiting example of a method for assembling an arrangement for mounting a microphone to an interior surface of a vehicle. At step 126, a housing and a microphone having an acoustic axis is provided. The microphone may be directional wideband microphone 98 or directional wideband microphone 112 or any other microphone having an acoustic axis. The housing may be housing 84 or any other housing suitable for mounting the microphone having an acoustic axis.

At step 128, the microphone is connected to the housing such that the housing and the microphone cooperate to unilaterally direct the acoustic axis in a desired direction and such that the housing does not alter the frequency response of the microphone. In some examples, the microphone may be connected to the housing such that the microphone directs the acoustic axis to extend in a direction that is substantially parallel to a central axis of the housing. In other examples, the microphone may be connected to the housing such that the microphone directs the acoustic axis to extend in a direction that is oblique to the central axis of the housing.

At step 130, the housing, with the microphone connected, is attached to a surface in a vehicle. For example, the housing may be pushed into position and mounted in a snap-fit fashion within an overhead console such as overhead console 78. In other examples, the housing may be screwed, bolted, or riveted into position. In other examples, the housing may be attached by adhesives or epoxies. In still other examples, the housing may be welded into position. In still other examples, any technique or fastener effective to mount the housing to the surface may be employed.

While at least one example has been presented in the foregoing detailed description, it should be appreciated that a vast number of variations exist. It should also be appreciated that the example or examples are not intended to limit the scope, applicability, or configuration in any way. Rather, the foregoing detailed description will provide those skilled in the art with a convenient road map for implementing the example or exemplary examples. It should be understood that various changes can be made in the function and arrangement of elements without departing from the scope as set forth in the appended claims and the legal equivalents thereof.

What is claimed is:

1. An arrangement for mounting a microphone to a surface in a passenger compartment of a vehicle, the arrangement comprising:
a housing having an opening, the housing being configured to be mounted to the surface; and
a directional wideband microphone mounted within the housing and positioned to partition the housing into a first chamber and a second chamber, the directional wideband microphone having an acoustic axis extending through the first chamber,
wherein the housing and the directional wideband microphone cooperate to direct the acoustic axis in a predetermined direction.

2. The arrangement of claim 1, wherein a volume of the first chamber and a volume of the second chamber are approximately equal.

3. The arrangement of claim 2, wherein an opening to the first chamber has a surface area that is approximately equal to an opening to the second chamber.

4. The arrangement of claim 1, wherein the directional wideband microphone is oriented to direct the acoustic axis to extend in a direction that is substantially parallel to a surface of the housing.

5. The arrangement of claim 1, further comprising a preamplifier electrically connected to the directional wideband microphone.

6. The arrangement of claim 5, wherein the preamplifier is mounted inside the directional wideband microphone.

7. The arrangement of claim 1, further comprising a boot partially surrounding the directional wideband microphone and wherein the boot and the directional wideband microphone cooperate to partition the housing into the first chamber and the second chamber.

8. The arrangement of claim 7, wherein the directional wideband microphone has a plurality of sound receiving surfaces, wherein the boot defines a plurality of openings, and wherein the plurality of openings are aligned with the plurality of sound receiving surfaces such that the plurality of sound receiving surfaces are substantially uncovered.

9. The arrangement of claim 1, further comprising an acoustic textile having a predetermined acoustic impedance, the acoustic textile at least partially covering the opening.

10. The arrangement of claim 1, wherein the directional wideband microphone is mounted to the housing such that the acoustic axis extends in a direction that is oblique to a surface of the housing.

11. An arrangement for mounting a microphone to a surface in a passenger compartment of a vehicle, the arrangement comprising:
a housing having an opening, the housing being configured to be mounted to the surface; and
a directional wideband microphone mounted within the housing and positioned to partition the housing into a first chamber and a second chamber, the directional wideband microphone having an acoustic axis extending through the first chamber, and the directional wideband microphone being positioned a distance from a far wall of the first chamber that is less than a length of a wavelength of a frequency of interest,
wherein the housing and the directional wideband microphone cooperate to direct the acoustic axis in a predetermined direction.

12. The arrangement of claim 11, wherein a volume of the first chamber and a volume of the second chamber are approximately equal.

13. The arrangement of claim 12, wherein an opening to the first chamber has a surface area that is approximately equal to an opening to the second chamber.

14. The arrangement of claim 11, further comprising a preamplifier electrically connected to the directional wideband microphone.

15. The arrangement of claim 14, wherein the preamplifier is mounted inside the directional wideband microphone.

16. The arrangement of claim 11, further comprising a boot partially surrounding the directional wideband microphone and wherein the boot and the directional wideband microphone cooperate to partition the housing into the first chamber and the second chamber.

17. The arrangement of claim 16, wherein the directional wideband microphone has a plurality of sound receiving surfaces, wherein the boot defines a plurality of openings, and wherein the plurality of openings are aligned with the plurality of sound receiving surfaces such that the plurality of sound receiving surfaces are substantially uncovered.

18. The arrangement of claim 11, further comprising an acoustic textile having a predetermined acoustic impedance, the acoustic textile at least partially covering the opening.

19. An arrangement for mounting a microphone to a surface in a passenger compartment of a vehicle, the arrangement comprising:
a housing having an opening, the housing being configured to be mounted to the surface;
a directional wideband microphone mounted within the housing and positioned to partition the housing into a first chamber and a second chamber, the directional wideband microphone having an acoustic axis extending through the first chamber, and the directional wideband microphone being positioned a distance from a far wall of the first chamber that is less than a length of a wavelength of a frequency of interest; and
a mass of sound absorbing material disposed in the first chamber,
wherein the housing and the directional wideband microphone cooperate to direct the acoustic axis in a predetermined direction.

20. The arrangement of claim 19, wherein the mass of sound absorbing material comprises a foam material.
